(19) United States
(12) Patent Application Publication
(10) Pub. No.: US 2003/0193805 A1
(43) Pub. Date: Oct. 16, 2003

(54) Method and apparatus for dispersing different genera of birds

(76) Inventors: Michael R. Matheson, Phoenix, AZ (US); Ronald A. Matheson, Phoenix, AZ (US)

Correspondence Address: Tod R. Nissle, Esq., TOD R. NISSLE, P.C., P.O. Box 55630, Phoenix, AZ, 85078, US

(21) Appl. No.: 10/120,773

(22) Filed: Apr. 10, 2002

(51) Int. Cl. F21V 14/00

(52) U.S. Cl. 362/276; 362/101; 362/145; 362/802

(57) ABSTRACT

A method is provided for dispersing birds. The method utilizes a horizontally oriented light beam. The light beam is positioned two to eight inches above the surface on which the birds sit. The beam, when it is normal to a birds' eye and strikes the eye, causes the bird discomfort and makes it fly away from the building structure.

This invention relates to apparatus and methods for dispersing birds from a particular location.

More particularly, the invention relates to methods and apparatus for dispersing different genera of birds without killing or injuring the birds.

Birds pose a safety hazard at airports and in building structures. Birds also damage agricultural fields.

Pigeons, for example, carry a variety of diseases which are dangerous and/or fatal to human beings. One of these diseases is histoplasmosis, which can cause death or blindness. The extreme health danger posed by pigeons has resulted in the decision to remove the pigeons from Trafalgar Square in London, England.

When pigeons roost in or on a building and produce droppings, the droppings function to carry and spread disease. After pigeons have roosted in a building for three months or more, the homing instinct of the pigeons makes it difficult to remove the pigeons without having to kill them. Once pigeons have roosted in a building, they are known to build nests on and sit on spikes or nails that are installed in their nesting area, even through the spikes cut the pigeons and cause them to bleed.

The United States Air Force has investigated a variety of methods to disperse pigeons and other birds. Each of the following methods had only a limited degree of success.

1. Ultrasonic devices. Air Force policy bans the use of ultrasonic devices because there evidently are no conclusive tests showing that such devices work.

2. Stuffed owls and rubber snakes. In Air Forces tests these devices had little or no affect on birds. Birds typically stand on or peck at these devices a few days after installation.

3. Rotating beacons and shiny objects. Lights, reflectors, etc. were found to affect birds at first by distracting or frightening them. The birds quickly, however, learn to recognize the steady sweep of the light or movement of the reflector. Strobe lights have shown no lasting results because the birds recognize that there is no real threat.

4. Loud music and other noises. When loud music is playing, birds usually move as far as possible from the sound source, but not out of the hanger. Human beings working in the hanger become aggravated by the noise, which aggravation is compounded when the birds realize there is no real threat.

5. Chemical irritants. Chemicals create a “hot foot” on a bird, or produce a tacky surface, making it uncomfortable for the bird to stand on the chemical. A principal disadvantage of chemical irritants is that they become covered with dust and debris and become ineffective.

Accordingly, it would be highly desirable to provide an improved method and apparatus for dispersing birds.

Therefore, it is a principal object of the instant invention to provide an improved method and apparatus for dispersing birds.

Another object of the invention is to provide an improved method and apparatus for dispersing birds without requiring the use of toxic chemicals or other weapons which kill the birds.

These and other, further and more specific objects of the invention will be apparent to those skilled in the art from the following detailed description thereof, taken in conjunction with the drawings in which:

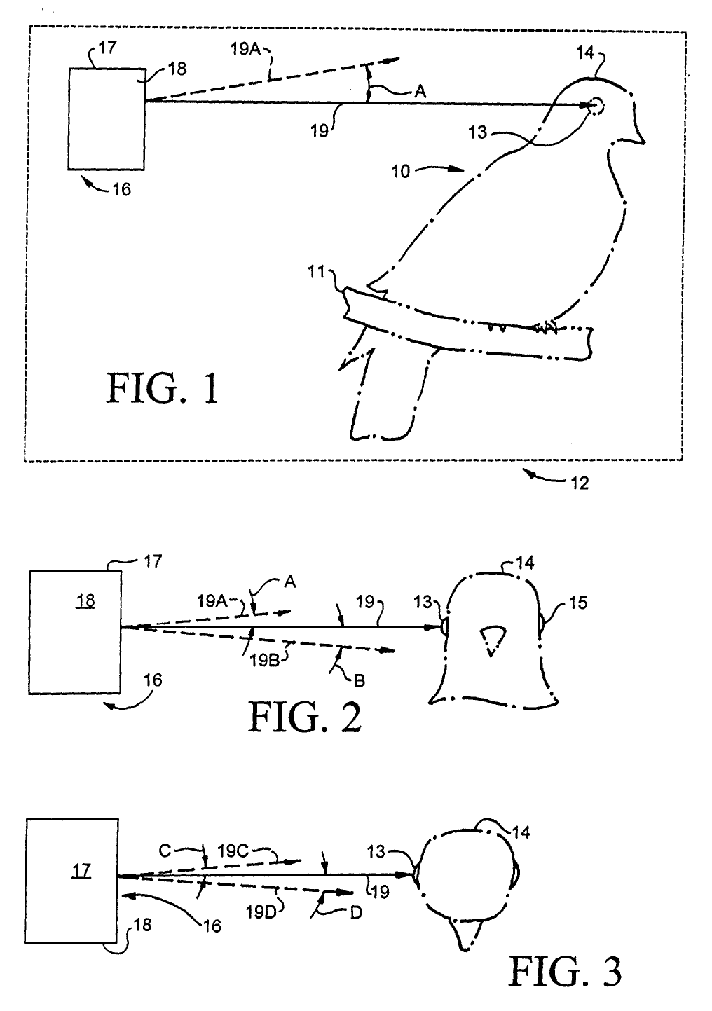

FIG. 1 is a perspective view illustrating the pigeon dispersal method of the invention;

FIG. 2 is a front view further illustrating details of the pigeon dispersal method of the invention;

FIG. 3 is a top view further illustrating details of the pigeon dispersal method of the invention; and

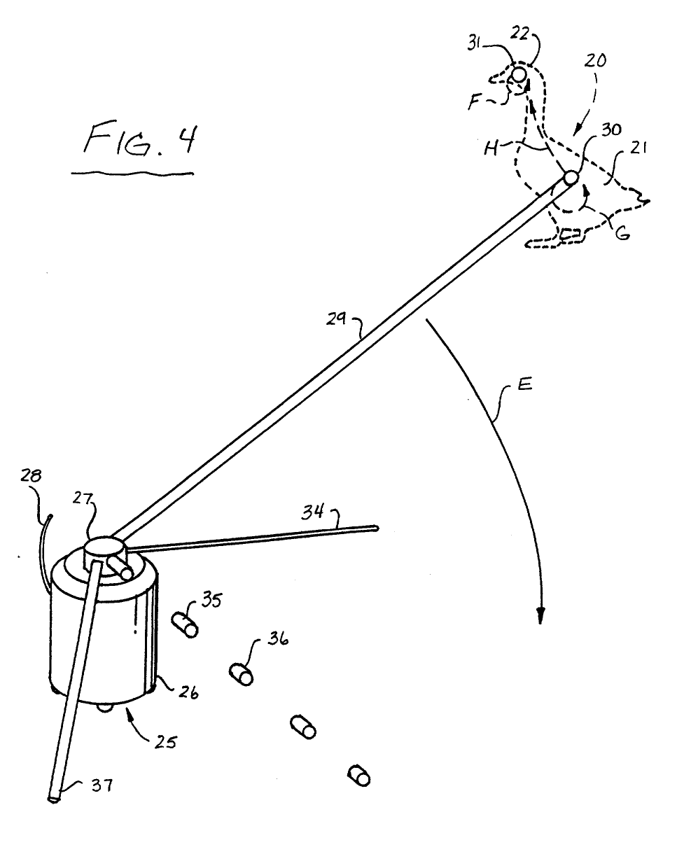

FIG. 4 is a perspective view illustrating the mode of operation of apparatus constructed in accordance with the invention.

Briefly, in accordance with the invention, I provide an improved method for dispersing a group of pigeons from a building structure in which the pigeons roost. The method includes the steps of identifying a roosting surface in the building on which the pigeons roost at night; providing a light source which, when activated, generates a beam that, on entering the eye of a pigeon normal to the eye, causes discomfort to the pigeon and causes the pigeon to fly away from the building structure; positioning the light source in the building structure such that when the light source is activated, the beam generated is generally horizontally oriented and travels over the roosting surface a distance above the surface in the range of two to six inches; activating at night the light source to produce the beam; and, repeating the last two steps during the night time on at least three consecutive days.

In another embodiment of the invention, I provide an improved method for dispersing a group of birds from an agricultural field when the birds have gathered on the field to feed. The method comprises the steps of providing a light source which, when activated, generates a beam of light; preparing the field to be planted with seed; planting the seed in the field; positioning the light source such that when the light source is activated the beam of light travels over at least a portion of the field along a generally horizontal path of travel a distance above the field in the range of one to eight inches; waiting for a flock of birds to land on the field to feed on the seed; and, activating the light source to generate the beam of light.

In a further embodiment of the invention, I provide a method for dispersing from a body of water a group of birds comprising web-footed swimmers in Anseres, a suborder of Anseriforms. The method includes the steps of providing a light source which, when activated, generates a moving beam of light; positioning the light source such that when the light source is activated the beam of light travels over at least a portion of the body of water along a generally horizontal path of travel a distance above the water in the range of two to twelve inches; waiting for a flock of birds of the suborder Anseres to land on the body of water; and, activating the light source to generate the moving beam of light such that the beam of light strikes the body of at least one of the flock and forms a visible image on the body of the one of the flock.

In still another embodiment of the invention I provide an improved method for dispersing a bird having a body and a head. The method includes the steps of providing a light source which, when activated, generates a beam of light; activating the light source to produce the beam of light in an orientation generally parallel to the ground; aiming the beam of light to impinge on the body of the bird to form a visible image on the body of the bird; moving the beam of light such that the beam of light remains generally parallel to the ground, and the image moves on the body of the bird.

In still a further embodiment of the invention, I provide an improved method for dispersing a bird having a body and a head. The method includes the steps of providing a light source which, when activated, generates a beam of light; activating the light source to produce the beam of light in an orientation generally parallel to the ground; aiming the beam of light to impinge on the head of the bird to form a visible image on the head of the bird; moving the beam of light such that the beam of light remains generally parallel to the ground, and the image moves on the head of the bird.

In still yet another embodiment of the invention, I provide an improved method for dispersing a bird having a body and a head. The method includes the steps of providing a light source which, when activated, generates a beam of light; activating the light source to produce the beam of light in an orientation generally parallel to the ground; aiming said beam of light to impinge on the body of the bird to form a visible image on the body of the bird; moving the beam of light such that the beam of light remains generally parallel to the ground, and the image moves on the body of the bird; moving the beam of light such that the beam of light remains generally parallel to the ground, and the image moves from the body of the bird to the head of the bird.

In still yet a further embodiment of the invention, I provide an improved method for dispersing from a tree a group of birds of the family Sturnidae. The method includes the steps of providing a light source which, when activated, generates a moving beam of light; mounting the light source in the tree such that when the light source is activated the beam of light travels along a path generally parallel to the ground; waiting for a flock of birds of the family Sturnidae to land in the tree such that when the light source is activated at least one of the flock of birds will be impinged by the moving light beam, a visible image will be formed by the light beam on the one of the flock of birds, and, the visible image will move on the one of the flock of birds; and, activating the light source to produce the moving beam.

In a further embodiment of the invention, I provide improved apparatus for dispersing birds. The apparatus includes a housing; light producing apparatus mounted on the housing to produce a light beam traveling along a path generally parallel to the ground, and having an intensity sufficient to form a visible image on a bird that is a selected distance from the apparatus; and, control apparatus mounted on the housing to vary at least one of a group consisting of the intensity of the light beam, the position of the light beam, and the continuity of the light beam.

In another embodiment of the invention, I provide an improved method for dispersing a group of birds. The method includes the step of providing apparatus including a housing; light producing apparatus mounted on the housing to produce when apparatus is activated a light beam traveling along a path generally parallel to the ground, and having an intensity sufficient to form a visible image on a bird that is a selected distance from the apparatus, and control apparatus mounted on the housing to vary when the apparatus is activated at least one of a group consisting of the intensity of the light beam, the position of the light beam, and the continuity of the light beam. The method also includes the steps of positioning the apparatus at a selected location where birds gather; waiting for a flock of birds to gather; activating the apparatus to produce the light beam; and, varying with the control apparatus at least one of the group.

In still a further embodiment of the invention, I provide an improved method for dispersing a group of birds. The method includes the step of providing apparatus including a housing; light producing apparatus mounted on the housing to produce when the apparatus is activated a light beam traveling along a path generally parallel to the ground, having an intensity sufficient to form a visible image on a bird that is a selected distance from the apparatus; and, control apparatus mounted on the housing operable to cause the beam to intermittently cycle on and off; positioning the apparatus at a selected location where birds gather; waiting for a flock of birds to gather; activating the apparatus to produce the light beam; and, operating the control apparatus to cause the beam to intermittently cycle on and off.

Turning now to the drawings, which describe the presently preferred embodiments of the invention for the purpose of illustrating the practice thereof and not by way of limitation of the scope of the invention, and in which like reference characters refer to corresponding elements throughout the several views, FIG. 1 illustrates a pigeon 10 sitting on a roosting surface 11 in a building structure 12. Surface 11 can be a beam, a roof, a chimney, roof air vent, or any other area in a building when pigeons congregate and roost. Pigeon 10 includes head 14 and eyes 13, 15. Light source 16 produces a light beam that travels along a path of travel 19. Source 16 includes a housing having a top 17 and a front 18. Path of travel 19 is horizontally oriented, i.e. is generally parallel to the ground.

The horizontal orientation of the path of travel 19 of the light beam is important in the practice of the invention because if the orientation of path of travel 19 becomes vertical or substantially vertical, it is unlikely that the light beam will be substantially normal to the eye of a pigeon or other bird and will produce discomfort sufficient to make the pigeon fly away from a building structure. Consequently, if the light beam 19 travels along a path 19A which is at an angle A from path 19 of more than thirty degrees, this is not preferred in the practice of the invention. Angle A (and angle B in FIG. 2) preferably is no more than ten degrees.

The paths of travel indicated by dashed lines 19A and 19B indicate the possible vertical inclination and declination of a light beam from the preferred horizontal path of travel 19. In contrast, since FIG. 3 is a top view, the paths of travel indicated by dashed lines 19C and 19D indicate the possible lateral displacement from the preferred path of travel 19 of a light beam entering the eye 13 of a pigeon.

As noted, the light beam is preferably normal to eye 13 when it enters eye 13. A light beam is normal to eye 13 when (1) the light beam is horizontally oriented (i.e., when the beam has a path of travel 19), (2) pigeon 10 is standing, waling, sitting, or laying down, (3) the side of the head of the pigeon is generally perpendicular to the path of travel 19 of the light beam in the manner indicated in FIGS. 2 and 3, and (4) the light beam travels along path 19 (i.e., along a path normal to the side of head 14), or, travels along a path 19A, 19B, 19C, 19D or other path which is not inclined, declines or laterally displaced from path 19 more than thirty degrees (preferably no more than ten degrees). Accordingly, if a pigeon 10 is standing, walking, sitting, or laying down with its head in a normal upright position, if the light beam travels along path 19 (i.e., is horizontally oriented) or a path not more than thirty degrees from path 19, and the side of the pigeon's head is normal to beam 19, then beam 19 is normal to eye 13. As noted, a path of travel of a light beam can be both vertically displaced (up or down) and laterally displaced from path 19.

When there are a plurality of pigeons or other birds at a roosting site in a hanger, roof, or other structure, causing one or two pigeons to leave can cause all or most of the other pigeons to leave. If a light beam 19 is directed through a roosting area 11 frequented by a plurality of pigeons, it is likely that a pigeon will walk, stand, sit, or lay down in front of the beam 19, have the beam 19 enter the pigeon's eye 13, cause discomfort to the pigeon, and cause the pigeon to leave the building structure, agricultural field, etc.

The intensity of beam 19 necessary to cause a pigeon 10 to leave a building site can vary and can be determined with minimal experimentation. For sake of example, a red laser sighting beam of the type utilized on pistols or rifles has been found sufficient to cause pigeons to leave when the pigeons are at a distance from the laser beam source of ten to twenty-five yards. The intensity of beam 19 necessary to cause to pigeon 10 to leave will vary depending on the distance of the roosting site (and of the pigeon) from the light source, but can be readily determined with experimentation. A light beam, even a so-called collimated light beam, tends to diverge with distance, reducing the intensity of the portion of the beam that strikes a pigeon or other bird in the eye.

Beam 19 can be collimated or not collimated.

The color of beam 19 can vary as desired, however, at night a red light beam 19 has been found effective while during the day a yellow or green beam has been found effective.

When an adult pigeon is walking, standing, sitting, or laying down, the height of the pigeon's eyes above the ground or roosting area or surface 11 is normally in the range of two to six inches. Therefore beam 19 is positioned from two to six inches above surface 11. The distance of beam 19 above surface 11 can vary as desired, especially if the apparatus and method of the invention are utilized to disperse birds other than pigeons which are of a size different than that of pigeons. Regardless of the size of the bird or birds involved, the objective is to strike the bird's eye or body with a horizontal beam that is normal to the eye when the bird is walking, standing, sitting or laying down, as the case may be.

The apparatus of the invention can be utilized during the day or at night. A night time application is preferred because the birds' eyes are adapted to take in more light at night and are therefore more sensitive to beam 19 and are more likely to be frightened and feel discomfort and fly away from a building structure. However, as will be described, if the proper methodology is utilized, birds can be effectively dispersed during the daytime.

The intensity of beam 19 or of light emanating from source 16 can, if desired, be great enough to injure the eye 13 of a pigeon 10 or other bird. This is not preferred in the practice of the invention. The intention of the invention is to make the intensity of beam 19 sufficient to cause discomfort without causing permanent injury, much like the discomfort experienced by a human being when glancing at the sun for a short period of time. Ordinarily, if an individual glances at the sun, the individual's eyes feel discomfort but are not permanently damaged. This risk of injury to a pigeon or other bird appears minimal and, the invention appears to provide a viable alternative to killing or poisoning pigeons because of the diseases associated with the pigeons.

Pigeons have a strong homing instinct. Once a pigeon has returned to and roosted at a particular location for more than two or three months, the pigeon is “seated” at that location and it often is difficult to convince the pigeon to leave and locate another roosting location.

It is believed that prior art attempts to make pigeons and other birds leave an area have failed or have been inconsistent for several reasons.

First, attempts which merely produce a scare factor—like stuffed owls and rubber snakes—are quickly apprised by the birds as not posing a danger.

Second, the strobes and other lights that have been used do not appear to have caused any significant discomfort to birds, often because the light is not normal to the head and eye of the bird and, even if it is normal, the intensity of the light is not sufficient to cause the bird discomfort. Birds, as do more animals who can see, are believed to be sensitive to the possibility of losing their sight (if nothing else they are instinctively afraid of losing their sight), but at the same time quickly learn when a light source poses no real danger.

Third, and most important, simply pointing a light at a bird is many times not sufficient to cause consistently a bird to leave an area. The methodology of how to use light with particular birds in particular circumstances is believed important. Such methodology does not appear to have been carefully understood or researched in the prior art. For example, with respect to pigeons, simply causing a pigeon discomfort once is not believed sufficient to cause the pigeon to leave a site where it is “seated” because the pigeon has roosted at the site for more than two months or three months. The light beam of the invention normally must be used usually during at least three consecutive days (during daytime, nighttime, or both) in a relatively short period of time. As used herein, consecutive days mean using the invention during (n−2) days during a period n days long. For example, during a seven day period, the invention must be used during at least five days. During a ten day period, the invention must be used during at least eight days. And so on. It is preferred, however, that the invention be used during each day of a set period of time. This usage is called a true consecutive day usage. During a true consecutive day usage, the invention is used each day during a selected period n days long. Each day the invention is utilized, it is preferably utilized at least during a selected period of time during the day. For example, there may be a particular time of afternoon or evening when the pigeons or other birds come to roost for the night. Or, if the invention is used in agricultural fields, woods, etc., there may be a particular time of afternoon or night when the pigeons or other birds land in a field to eat seeds and other food that is on or in the ground. In some cases, the light beam 19 may have to be used four to ten consecutive days or more to remove pigeons from a roosting site. This could especially be the case if pigeons have roosted at a selected building structure or other location for two or three years. At locations where pigeons or other birds are not “seated” and are not roosting, using the apparatus of the invention for at least a part of the day for only one, or two, or three days may be sufficient.

When light beam 19 is used during a twenty-four hour day, the time beam 19 is “on” can vary as desired. Beam 19 can be turned on every minute during a day, can only be turned on at night, can be turned on during a particular portion of the night (or daytime), etc. depending on the habits of the pigeons, use of the building structure, and any other factors which might be taken into account. Regardless of how long during each day beam 19 is turned on, the objective is to make it likely that at least one pigeon (or other bird) in a group of pigeons (or other birds) at a roosting site will be struck in the eye 13 by beam 19 so that the pigeon feels discomfort and flies away from the roosting site or other site, preferably flying away immediately after beam 19 strikes the pigeon 10 in eye 13.

Beam 19 can shine along one fixed path, can be rotated like the light in a lighthouse, can repeatedly turn on and off, can pulsate, etc.

As used herein, a pigeon or other bird roosts at a selected site or building structure if the pigeon returns to the site at least once each day for a period of at least seven consecutive days. When a pigeon returns to a site during the night each day this is a further indication that the pigeon is roosting at the site.

As used herein, a light beam 19 causes discomfort to a pigeon if when (1) light beam 19 is normal to the pigeon's eye 13 (i.e., normal when angles A to D are thirty degrees or less, preferably ten degrees or less), and (2) pigeon 10 flies away from a building structure when beam 19 enters eye 13.

The following examples are provided to demonstrate the importance of methodologies used in the practice of the invention, and not by way of limitation of the scope of the invention.

### EXAMPLE 1

Dispersement apparatus is provided that, once activated, produces a red laser beam. When the beam impinges at night a bird at a distance one hundred yards away from the apparatus, a visible one inch diameter red circular image is produced on the body of the bird.

A flock of geese, ducks and other birds of the family Anatidae of the order Anserifromes, frequents a selected area in a body of water. The area has a width of about two hundred yards.

The dispersement apparatus is positioned at night adjacent the selected area.

A flock of Anatidae birds arrives and land in the selected area. As used herein, a flock of birds comprises fifteen or more birds.

The dispersement apparatus is activated to produce a red laser beam. The beam is directed at the body of one of the birds and produces a visible red circular image on the body of the bird. As the bird swims and move over the surface of the water, the beam is moved such that the red circular image on the bird “travels” with and remains substantially stationary on the body of the bird. The bird sees the image and is agitated, but continues to swim in the water. After about a minute passes from the time when the image is first formed on the bird's body, the beam is moved in a circular motion so that the image formed on the bird's body moves around on the bird's body. The bird becomes more agitated, and in about fifteen seconds, takes flight and leaves the selected area. The other members of the flock also take flight and leave the selected area.

The fact that a flock of birds in the family Anatidae can be dispersed without have to direct a beam of light at the face of the birds reduces the risk of injury to the birds.

### EXAMPLE 2

Example 1 is repeated, except that (1) the dispersement apparatus produces a green laser beam that produces a circular green image on the body of a bird at a range of one hundred yards, and (2) the flock lands in the selected area during daytime. Similar results are obtained.

### EXAMPLE 3

Example 1 is repeated, except that when the dispersement apparatus is activated, the red laser beam is directed at the head, instead of the body, of one of the birds and produces a visible red circular image on the head and eye of the bird. As the bird swims and moves over the surface of the water, the beam is moved such that the red circular image on the bird's head moves around the head. The bird becomes agitated. After the red image moves over the head and eye of the bird for a total of about thirty seconds the bird becomes more agitated, takes flight, and leaves the selected area. The other members of the flock also take flight and leave the selected area.

### EXAMPLE 4

Example 1 is repeated, except that (1) the dispersement apparatus produces a green laser beam that produces a circular green image on the body of a bird at a range of one hundred yards, and (2) the flock lands in the selected area during daytime. Similar results are obtained. The range of the green laser beam or other light beam can vary as desired, but presently is from ten yards to one hundred yards.

### EXAMPLE 5

Dispersement apparatus is provided that, once activated, produces a red laser beam. When the beam impinges at night a bird at a distance one hundred yards away from the apparatus, a visible one inch diameter red circular image is produced on the body of the bird.

A flock of small to medium sized birds of the family Turdidae of the suborder Passeres of the order Passeriformes frequent, frequents a selected roosting area in the countryside. The family Turdidae includes singing birds having specialized vocal apparatus with four or five pair of discromydian syringeal muscles. The family Turdidae includes blackbirds, mistle thrush, field fare, gray-cheeked thrust, hermit thrush, mistle thrush, olive-back thrush, redwings, robins, song thrush, varied thrush, veery, wood thrush, bill, bluebirds, and warblers. The flock also frequents a nearby agricultural field which recently has been prepared for seeding and has been seeded. The flock lands on the field to feed on seed applied during seeding.

The dispersement apparatus is positioned during the day adjacent the selected roosting area.

The flock of Turdidae birds arrives and lands in the roosting area.

The dispersement apparatus is activated to produce a red laser beam. The beam is directed at the body of one of the birds and produces a visible red circular image on the body of the bird. If the bird moves by walking, the beam is moved such that the red circular image on the bird “travels” with and remains substantially stationary on the body of the bird. The bird sees the image and is agitated, but continues to walk about. After about a five minutes passes from the time when the image is first formed on the bird's body, the beam is moved in a circular motion so that the image formed on the bird's body moves around on the bird's body. The bird becomes more agitated, and in about thirty seconds, takes flight and leaves the selected area. The other members of the flock also take flight and leave the selected area.

### EXAMPLE 6

Example 5 is repeated, except that the dispersement apparatus is positioned adjacent the agricultural field, and the flock of Turdidae birds lands in the agricultural field to feed. After about one minute passes from the time when the red laser beam is directed at the body of one of the birds and the image is first formed on the bird's body, the bird takes flight and leaves the selected area. The other members of the flock also take flight and leave the selected area.

### EXAMPLE 7

Example 5 is repeated, except that the birds in the flock are in the family Anatidae instead of in the family Turdidae. Similar results are obtained.

### EXAMPLE 8

Example 6 is repeated, except that the birds in the flock are in the family Anatidae instead of in the family Turdidae. Similar results are obtained.

### EXAMPLE 9

The flock of Anatidae birds dispersed from the selected body of water in Example 1 returns to that body of water within the next several days. The dispersement apparatus of Example 1 is used in the manner set forth in Example 1 with similar results, i.e., the flock of birds takes flight and leaves the selected body of water. The flock of birds does not return to the selected area in the body of water for at least a month.

### EXAMPLE 10

The flock of Anatidae birds dispersed from the selected body of water in Example 2 returns to that body of water within the next several days. The dispersement apparatus of Example 2 is used in the manner set forth in Example 2 with similar results, i.e., the flock of birds takes flight and leaves the selected body of water. The flock of birds does not return to the selected area in the body of water for at least a month.

### EXAMPLE 11

The flock of Anatidae birds dispersed from the selected body of water in Example 3 returns to that body of water within the next several days. The dispersement apparatus of Example 3 is used in the manner set forth in Example 3 with similar results, i.e., the flock of birds takes flight and leaves the selected body of water. The flock of birds does not return to the selected area in the body of water for at least a month.

### EXAMPLE 12

The flock of Anatidae birds dispersed from the selected body of water in Example 4 returns to that body of water within the next several days. The dispersement apparatus of Example 4 is used in the manner set forth in Example 4 with similar results, i.e., the flock of birds takes flight and leaves the selected body of water. The flock of birds does not return to the selected area in the body of water for at least a month.

### EXAMPLE 13

The flock of Turdidae birds dispersed from the roosting area in Example 5 returns to that area within the next several days. The dispersement apparatus of Example 5 is used in the manner set forth in Example 5 with similar results, i.e., the flock of birds takes flight and leaves the roosting area. The flock of birds does not return to the roosting area for at least a month.

### EXAMPLE 14

The flock of Turdidae birds dispersed from the agricultural field in Example 6 returns to the agricultural field within the next several days. The dispersement apparatus of Example 6 is used in the manner set forth in Example 6 with similar results, i.e., the flock of birds takes flight and leaves the agricultural field. The flock of birds does not return to the agricultural field for at least a month.

### EXAMPLE 15

The flock of Anatidae birds dispersed from the roosting area in Example 7 returns to that area within the next several days. The dispersement apparatus of Example 7 is used in the manner set forth in Example 7 with similar results, i.e., the flock of birds takes flight and leaves the roosting area. The flock of birds does not return to the roosting area for at least a month.

### EXAMPLE 16

The flock of Anatidae birds dispersed from the agricultural field in Example 8 returns to the field within the next several days. The dispersement apparatus of Example 8 is used in the manner set forth in Example 8 with similar results, i.e., the flock of birds takes flight and leaves the agricultural field. The flock of birds does not return to the agricultural field for at least a month.

### EXAMPLE 17

Dispersement apparatus is provided that, once activated, continuously produces a red laser beam having an unchanging intensity and continuity. As used herein, the intensity of a light beam is the brightness of the beam. The brightness of the beam is the amount of light produced by the light source, i.e., produced by the dispersement apparatus. The amount of light produced by the dispersement apparatus is called the luminous intensity. The stand unit used to measure luminous intensity is the candela. The intensity of the light beam is different than the intensity of the light beam when it reaches the surface of a bird or other object. Illuminance indicates the intensity of light falling on a surface, and is different from the luminous intensity. As noted, as used herein, the intensity of a light beam is the luminous intensity of the beam, and is not luminance.

As used herein, continuity indicates whether the luminous intensity is constant or is changing. If a light beam has an unchanging continuity, then the luminous intensity of the beam is not changing when the beam is on. If a light beam has a changing continuity, then the luminous intensity of the beam is changing while the beam is on. A changing continuity can be obtained by pulsing the light beam. A light beam can be pulsed by turning the light source on and off. Another example of changing continuity is altering the brightness of a light source with a dimmer switch.

The position of the light beam is constant during a selected period of time if, during the selected period of time, the light beam stays in the same spot and orientation without moving. Moving the beam up or down or laterally changes the position of the light.

As used herein, the shape of the light beam is the shape of the cross-sectional area of the light beam. The shape of the cross-section area of the light beam is generally equivalent to the shape of the image produces when the beam impinges an object. When the image formed by a light beam on the body of a bird is circular, then the cross-sectional area of the light beam is circular and the shape of the light beam is circular.

The red laser beam produced by the dispersement apparatus is aimed or directed at the body of a pigeon in an effort to make the pigeon leave a roosting area. The beam has unchanging intensity and continuity. The position of the beam, i.e., the position of the image formed on the body of the pigeon, does not change. If, however, the pigeon moves, the beam “follows” the pigeon so the image formed on the body of the pigeon remains in substantially fixed position.

The beam impinges the body of the pigeon and produces a visible one inch diameter red circular image on the body of the pigeon. The pigeon is agitated by the beam and the circular image. The pigeon does not, however, leave the roosting area, even after the circular image is formed on the body of the pigeon for a first time period of five minutes. After this initial five minute period expires, the beam is moved around for a second time period of five minutes such that the visible red circular image formed on the pigeon's body moves around on the body. This also appears to agitate the pigeon, but the pigeon still does not leave the roosting area. After the second five minute period expires, during a third time period the beam is moved such that the stationary visible red circular image is formed on, extends over, and is motionless on the head and eye(s) of the pigeon. This further agitates the pigeon, and after the first several minutes of the third time period, the pigeon takes flight and leaves the area.

### EXAMPLE 18

Example 17 is repeated, except that during the first and second time period the light beam is not continuous, but is pulsating. The beam is turned on and off. Each time the beam is turned on, the luminous intensity is the same. The pigeon does not leave during the first time period, but after four minutes of the second time period have elapsed the pigeon takes flight and leaves the area.

### EXAMPLE 19

Example 17 is repeated, except that during the first and second time period the intensity of the light beam is not constant, but changes while the beam is on. The intensity of the beam ebbs and flows, much light a light being operated by a dimmer switch that turns the light “up” and “down”. The pigeon does not leave during the first time period, but after three minutes of the second time period have elapsed the pigeon takes flight and leaves the area.

### EXAMPLE 20

Example 17 is repeated, except that during the first and second time period the light beam repeatedly moves through an arc. During the first and second time periods, the light beam forms a circular red image on the body of the bird during about 25% of the time that the beam cycles through the arc. The pigeon does not leave during the first five minute time period, but after two minutes of the second time period have elapsed the pigeon takes flight and leaves the area.

### EXAMPLE 21

Example 17 is repeated, except that during the first time period the light beam pulsates, continuously repeatedly moves through an arc, and has varying intensity. The pigeon takes flight and leaves the area after four minutes of the first time period have elapsed.

### EXAMPLE 22

Dispersement apparatus is provided that, once activated, produces a red laser beam. When the beam impinges at night a bird at a distance of ten yards to one hundred yards away from the apparatus, a visible one inch diameter red circular image is produced on the body of the bird.

A flock of starlings of the family Sturnidae gathers in a tree during the later afternoon or evening. In the United States, starlings are a member of the family Icteridae. As used herein, the family Sturnidae include the family Icteridae.

The dispersement apparatus is positioned above the ground in the tree so it is likely that when the apparatus is activated the light beam will impinge on the head or body of a starling in the tree, and, so the beam produced by the apparatus is generally parallel to the ground (to with±thirty degrees). The beam need not be parallel to the ground, but, as earlier explained, such an orientation of the beam is preferred. The apparatus can, if desired, produce simultaneously multiple light beams.

The flock of Sturnidae birds arrives in the late afternoon (during daylight) and lands in the tree. As used herein, a flock of birds comprises fifteen or more birds.

The dispersement apparatus is activated to produce a red laser beam. The beam impinges the body of one of the starlings and forms a visible red circular image on the body. The starling is agitated and jumps to another branch. The beam impinges the head of another starling and forms a visible red circular image on the head. That starling is also agitated and jumps to another branch in the tree. The beam impinges the head and eye(s) of a third starling and forms a visible red circular image on the head. The third starling squawks and takes flight. The first two starling impinged by the beam also take flight and are followed by the remaining birds in the flock.

### EXAMPLE 23

Example 22 is repeated, except that when the dispersement apparatus is activated the intensity, continuity, shape, and position of the light beam vary. The position of the light beam is varied by rotating continuously the beam through a three hundred and sixty degree arc and by having the beam rotate through portions of the housing having different indices of refraction. The continuity of the beam varies because the apparatus turns the beam on and off. The intensity of the beam varies because while the beam is on the luminous intensity varies. The shape of the beam varies because the beam rotates past an opening which permits only a semi-circular portion of the beam to escape so that a semi-circular image is formed on the body of a bird when the beam impinges the body of the bird.

Within the first minute after the dispersement apparatus was activated, the light beam produced by the apparatus had impinged multiple birds and had caused the flock to take flight and leave the tree. The dispersement apparatus can be constructed as a stand along unit that sets on the ground, as a unit hanging from a tree or other support, as a hand held apparatus, or in any other desired configuration.

### EXAMPLE 24

Examples 5, 6, 13, 14, 17 to 23 are repeated, except that the birds being dispersed in said examples are from the family Corvidae. Similar results are obtained.

### EXAMPLE 25

Examples 17 to 21 are repeated, except that the birds being dispersed in said examples are from the family Accipitridae. Similar results are obtained.

### EXAMPLE 26

Examples 17 to 21 are repeated, except that the birds being dispersed in said examples are from the order Falconiformes. Similar results are obtained.

### EXAMPLE 27

Examples 17 to 21 are repeated, except that the birds being dispersed in said examples are from the order Strigiformes. Similar results are obtained.

### EXAMPLE 27

Examples 9 to 16 are repeated. The results are similar, except that the birds, instead of not returning for at least a month, do not return for a year.

FIG. 4 illustrates a stand alone dispersement apparatus constructed in accordance with the invention and generally indicated by reference character 25. Apparatus includes housing 26. A light, diode, laser unit, or other light producing apparatus is housed by a transparent cover 27. Cover 27 is presently preferably made from glass to facilitate cleaning apparatus 25 without altering the light transmission properties of cover 27. Cover 27 is waterproof or water resistance and effectively seals the light producing apparatus (not visible) inside cover 27. The light producing apparatus, along with cover 27, is mounted on housing 26. Ground engaging wheels are attached to the bottom of cylindrical housing 26. The ground engaging wheels can, if desired, be omitted. Fiber optic antenna 28 receives signals that are utilized to activate apparatus 25 to turn on the light producing apparatus.

Apparatus 25 can produce a beam 29 that has a circular shape, does not change position, does not change intensity, and does not change continuity. Apparatus 25 can produce simultaneously multiple beams. Apparatus 25 can produce beams that shine continuously during a selected period of time or that turn on and off and sihine intermittently during the selected period of time. Apparatus 25 can also alter the luminous intensity of the beam produced by the light producing apparatus so that a beam 34 having an intensity less than (or greater than) that of beam 29 is produced. Apparatus 25 can also alter the continuity of beam 29 so that a “beam” of light pulses 35, 36 is produced by turning the light producing apparatus on and off. Apparatus 25 can also alter the shape of beam 29 so that a beam 37 have a different cross-sectional area is produced. The cross-sectional area of beam 29 is circular. The cross-secitonal area of beam 37 is semi-circular. Apparatus 25 can also alter the position of a beam 29 by making the beam 29 rotate in the direction of arrow E through an arc substantially parallel to the ground. In addition to moving the beam laterally, apparatus 25 can make a beam 29 move up or down to alter the position of the beam.

When beam 29 impinges the body 21 of a goose 20 or other bird, a visible circular image 30 is formed on the body 21. It is important in the practice of the invention to move image 30 around on body 21. The image 30 is preferably, but not necessarily, moved continously on the body 21 until the bird leaves the area. Such movement can be along a circular path indicated by arrow G, can be up and down, can be back and forth laterally, or any combination of the same. Such movement appears much more effective than keeping image 30 is a fixed stationary position on body 21.

It can also be important, to first form image 30 on the body 21 of a bird, and to then, after a selected period of time, move in the direction indicated by arrow H or along some other desired path to the bird's head and form an image 31 on the head and eye of the bird. Birds appear to be much more sensitive about their eyes, and if the bird has been watching with disapproval the image 30 on its body, and the image 31 suddenly impinges the bird's head and eye(s), it can cause a bird to leave immediately. When an image 31 is formed on the head 22 of a bird 20, moving the image in the direction indicated by arrow F or in other desired directions is also important.

Having described my invention in such terms as to enable those skilled in the art to practice it, and having described the presently preferred embodiments and best mode thereof, I claim:

1. A method for dispersing a group of pigeons from a building structure in which the pigeons roost, said method comprising the steps of
(a) identifying a roosting surface in the building on which the pigeons roost at night;
(b) providing a light source which, when activated, generates a beam that, on entering the eye of a pigeon normal to the eye, causes discomfort to the pigeon and causes the pigeon to fly away from the building structure;
(c) positioning said light source in the building structure such that when said light source is activated, said beam is generally horizontally oriented and travels over said roosting surface a distance above said surface in the range of two to six inches;
(d) activating at night said light source to produce said beam; and,
(e) repeating steps (c) and (d) during the night time on at least three consecutive days.

2. A method for dispersing a group of birds from an agricultural field, comprising the steps of
(a) providing a light source which, when activated, generates a beam of light;
(b) preparing the field to be planted with seed;
(c) planting the seed in the field;
(d) positioning said light source such that when said light source is activated said beam of light travels over at least a portion of said field along a generally horizontal path of travel a distance above the field in the range of one to eight inches;
(e) waiting for a flock of birds to land on the field to feed on the seed; and,
(f) activating said light source to generate said beam of light.

3. A method for dispersing from a body of water a group of birds comprising web-footed swimmers in Anseres, a suborder of Anseriforms, comprising the steps of
(a) providing a light source which, when activated, generates a moving beam of light;
(b) positioning said light source such that when said light source is activated said beam of light travels over at least a portion of said body of water along a generally horizontal path of travel a distance above the water in the range of two to twelve inches;
(c) waiting for a flock of birds of the suborder Anseres to land on the body of water; and,
(f) activating said light source to generate said moving beam of light such that said beam of light strikes the body of at least one of said flock and forms a visible image on the body of said one of said flock.

4. A method for dispersing a bird having a body and a head, comprising the steps of
(a) providing a light source which, when activated, generates a beam of light;
(b) activating said light source to produce said beam of light in an orientation generally parallel to the ground;
(c) aiming said beam of light to impinge on the body of the bird to form a visible image on the body of the bird;
(d) moving said beam of light such that
(i) said beam of light remains generally parallel to the ground, and p2 (ii) said image moves on the body of the bird.

5. A method for dispersing a bird having a body and a head, comprising the steps of
(a) providing a light source which, when activated, generates a beam of light;
(b) activating said light source to produce said beam of light in an orientation generally parallel to the ground;
(c) aiming said beam of light to impinge on the head of the bird to form a visible image on the head of the bird;
(d) moving said beam of light such that
(i) said beam of light remains generally parallel to the ground, and
(ii) said image moves on the head of the bird.

6. A method for dispersing a bird having a body and a head, comprising the steps of
(a) providing a light source which, when activated, generates a beam of light;
(b) activating said light source to produce said beam of light in an orientation generally parallel to the ground;
(c) aiming said beam of light to impinge on the body of the bird to form a visible image on the body of the bird;
(d) moving said beam of light such that
(i) said beam of light remains generally parallel to the ground, and
(ii) said image moves on the body of the bird; and,
(e) moving said beam of light such that
(i) said beam of light remains generally parallel to the ground, and
(ii) said image moves from the body of the bird to the head of the bird.

7. A method for dispersing from a tree a group of birds of the family Sturnidae, comprising the steps of
(a) providing a light source which, when activated, generates a moving beam of light;
(b) mounting said light source in the tree such that when said light source is activated said beam of light travels along a path generally parallel to the ground;
(c) waiting for a flock of birds of the family Sturnidae to land in the tree such that when said light source is activated
(i) at least one of the flock of birds will be impinged by said moving light beam,
(ii) a visible image will be formed by said light beam on said one of the flock of birds, and
(iii) said visible image will move on said one of the flock of birds; and,
(d) activating the light source to produce said moving beam.

8. Apparatus for dispersing birds including
(a) a housing;
(b) means mounted on said housing to produce a light beam
(i) traveling along a path generally parallel to the ground, and
(ii) having an intensity sufficient to form a visible image on a bird that is a selected distance from the apparatus;
(c) means mounted on said housing to vary at least one of a group consisting of
(i) the intensity of said light beam,
(ii) the position of said light beam, and
(iii) the continuity of said light beam.

9. A method for dispersing a group of birds, comprising the steps of
(a) providing apparatus including
(i) a housing,
(ii) means mounted on said housing to produce when said apparatus is activated a light beam
traveling along a path generally parallel to the ground, and
having an intensity sufficient to form a visible image on a bird that is a selected distance from the apparatus, and
(iii) control means mounted on said housing to vary when said apparatus is activated at least one of a group consisting of
the intensity of said light beam,
the position of said light beam, and
the continuity of said light beam;
(b) positioning said apparatus at a selected location where birds gather;
(c) waiting for a flock of birds to gather;
(d) activating said apparatus to produce said light beam; and,
(e) varying with said control means at least one of said group.

10. A method for dispersing a group of birds, comprising the steps of
(a) providing apparatus including
(i) a housing,
(ii) means mounted on said housing to produce when said apparatus is activated a light beam
traveling along a path generally parallel to the ground, and
having an intensity sufficient to form a visible image on a bird that is a selected distance from the apparatus, and
(iii) control means mounted on said housing operable to cause said beam to intermittently cycle on and off;
(b) positioning said apparatus at a selected location where birds gather;
(c) waiting for a flock of birds to gather;
(d) activating said apparatus to produce said light beam; and,
(e) operating said control means to cause said beam to intermittently cycle on and off.
